(19) United States
(12) Patent Application Publication
(10) Pub. No.: US 2024/0057817 A1
(43) Pub. Date: Feb. 22, 2024

(54) DONUT FRYING MACHINE AND METHOD THEREOF

(71) Applicant: Belshaw Bros., Inc., Auburn, WA (US)

(72) Inventors: Peter Nielsen, Auburn, WA (US); Stan Dettloff, Auburn, WA (US)

(21) Appl. No.: 18/453,907

(22) Filed: Aug. 22, 2023

Related U.S. Application Data
(60) Provisional application No. 63/399,767, filed on Aug. 22, 2022.

(51) Int. Cl. A47J 37/12; A23L 5/10

(52) U.S. Cl. CPC A47J 37/1214; A23L 5/11

(57) ABSTRACT

A machine for cooking a food item having at least a first portion and a second portion can include a vessel sized and shaped to receive a frying medium, the vessel having an entrance region and an exit region, a frame that coupleably receives the vessel, and a submerger system that submerges the food item to cook at least the first and the second portions. Related apparatuses, systems, and methods are also provided.

### BACKGROUND

### Technical Field

The present disclosure generally relates to donut frying machines.

### Description of the Related Art

Dough-based food products or items are typically made commercially by cooking them in frying machines. For example, certain dough-based products, such as, for example, donuts, are inserted into a frying machine that includes shortening. The shortening or other frying medium is provided in a vessel or tank, in which the donuts are fried. The frying machines also include a conveyor system which facilitates movement of the donuts across the vessel as they are fried.

As the donuts have to be fried on both sides, such conventional frying machines include a flipping device, for example, in the form of grills or trays. As the donuts pass through the shortening and after one side is fried, the donuts reach the flipping device. The flipping device receives the donuts and then rotates to flip the donut such that the side of the donut that was not fried is now submerged in the shortening. Such apparatuses, methods, and systems are inefficient because the donuts may not always flip and the cooking or frying process takes longer. Further, such apparatuses and systems are costly to manufacture and maintain. Additionally, even if the donuts are flipped appropriately, certain surfaces or portions of the donuts may not be completely submerged in the shortening, and thus certain portions of the donuts may remain incompletely cooked.

### BRIEF SUMMARY

The various embodiments described herein provide donut frying machines and related apparatuses, systems, devices, and methods that improve cooking dough-based food items, e.g., donuts, with efficient and robust form factors. For example, in one example embodiment, a machine for cooking a food item having at least a first portion and a second portion can be summarized as including a vessel sized and shaped to receive a frying medium, the vessel having an entrance region and an exit region, and a frame that coupleably receives the vessel. The machine includes a submerger system that submerges the food item to cook at least the first and the second portions.

For example, in another example embodiment, a submerger system that is configured to cook a food item can be summarized as including a cascade system which provides a first volume of shortening to cook an exposed portion of the food item, and a roller apparatus having a roller which, when positioned above the food item, submerges the food item in a second volume of shortening. The submerger system also includes one or more submerger plates, the one or more submerges arranged to submerge the food item in the second volume of shortening.

For example, in another embodiment, a method for cooking food items in a frying machine can be summarized as including supplying uncooked food items via an entrance region of the frying machine, and submerging the uncooked food item in a first food frying medium to cook a portion of the food item immersed in the first food frying medium. The method also includes supplying a second food frying medium to an exposed portion of the food item that faces away from the first food frying medium.

### BRIEF DESCRIPTION OF THE SEVERAL VIEWS OF THE DRAWINGS

FIG. 1 is a perspective view of a donut frying machine, according to one example embodiment.

FIG. 2 is a perspective view of the donut frying machine of FIG. 1 with a submerger system removed for clarity of illustration and description.

FIG. 3 is a plan view of the donut frying machine of FIG. 1.

FIG. 4 is a right side view of the donut frying machine of FIG. 1.

FIG. 5 is a rear view of the donut frying machine of FIG. 1.

FIG. 6 is a front view of the donut frying machine of FIG. 1.

FIG. 7 is a portion of a cross-sectional view of the donut frying machine of FIG. 1 taken along line 7-7.

FIG. 8 is the portion of the cross-sectional view of FIG. 7 with certain components removed for clarity of illustration and description.

FIG. 9 is a perspective view of a donut frying machine, according to another example embodiment.

FIG. 10 is a plan view of the donut frying machine of FIG. 9.

FIG. 11 is a perspective view of a submerger system of the donut frying machine of FIG. 9, according to one example embodiment.

### DETAILED DESCRIPTION

In the following description, certain specific details are set forth in order to provide a thorough understanding of various disclosed implementations. One skilled in the relevant art will recognize that implementations may be practiced without one or more of these specific details. In other instances, well-known structures and devices associated with donut making machines and related apparatuses, systems, and methods may not be shown or described in detail to avoid unnecessarily obscuring descriptions of the implementations.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

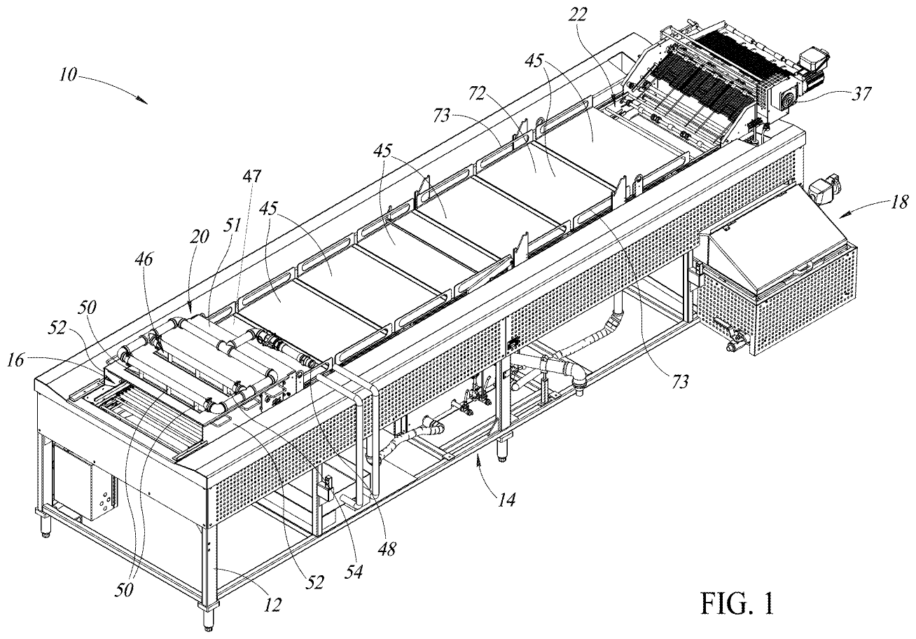

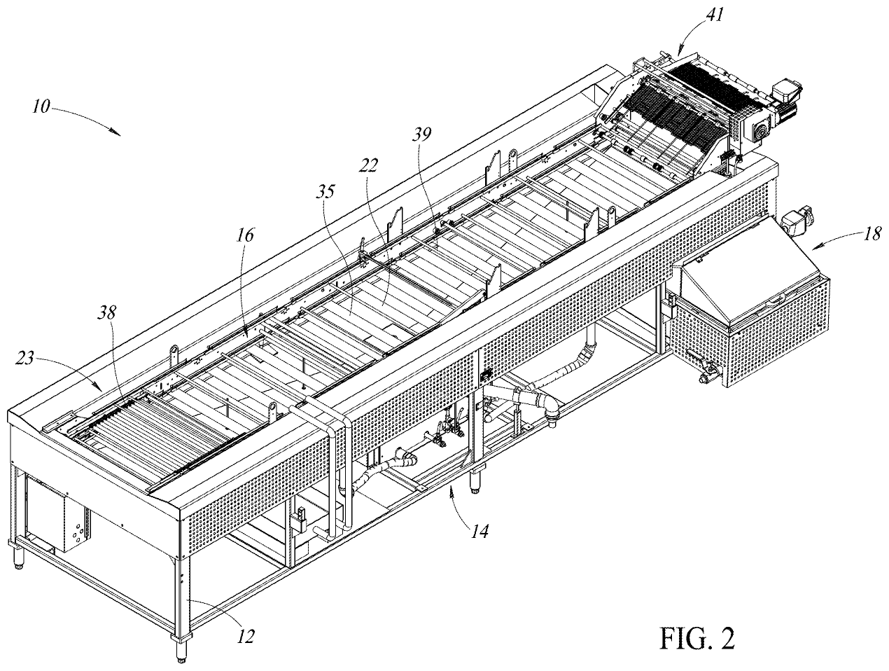

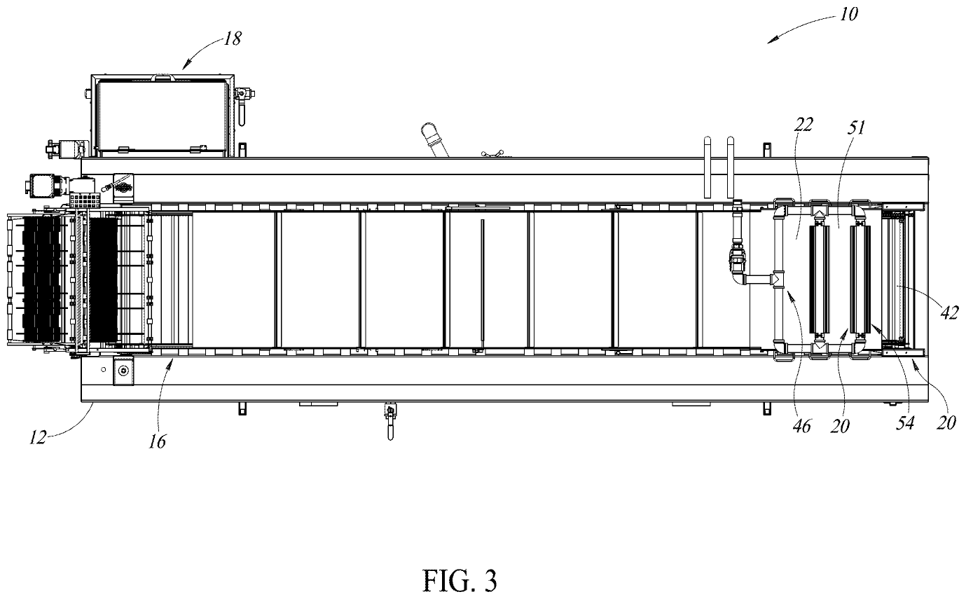

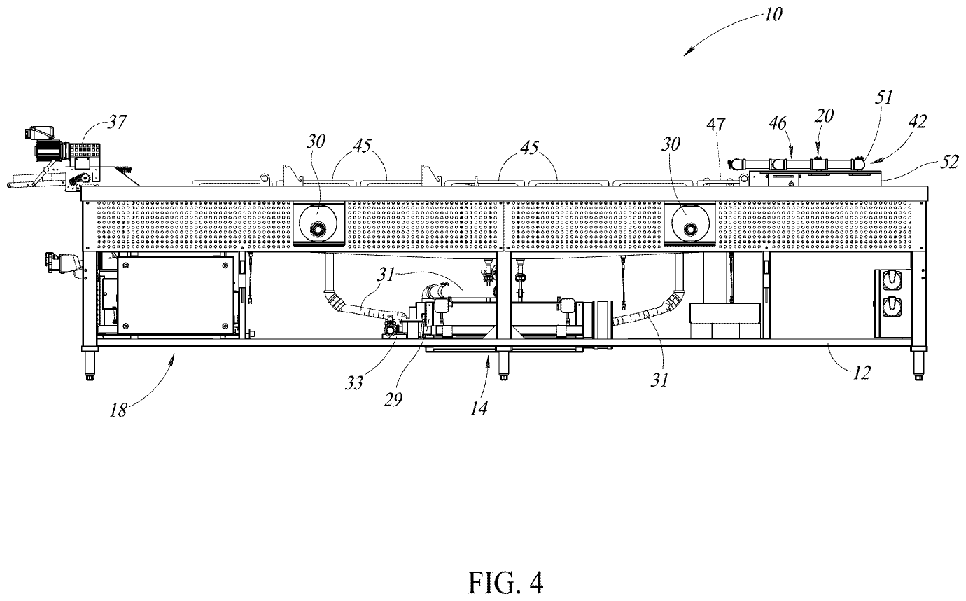

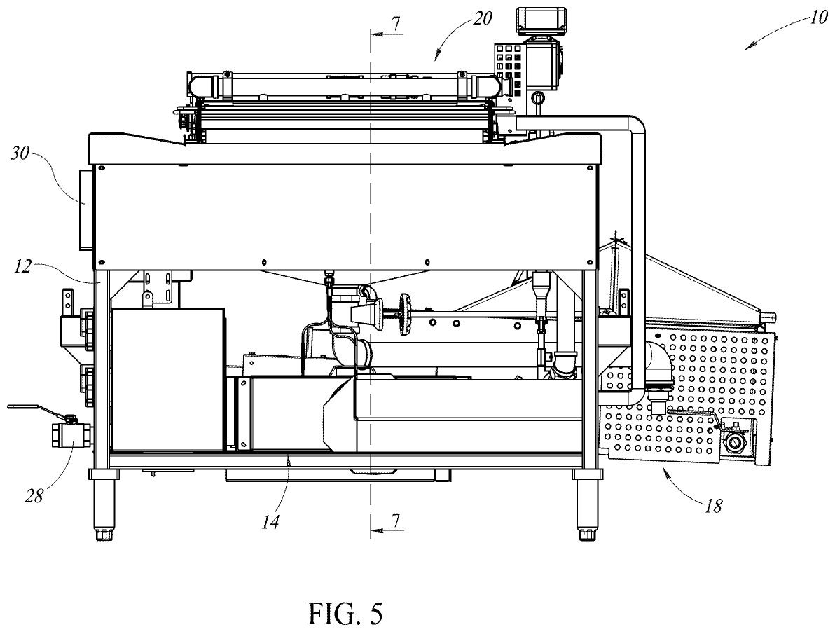

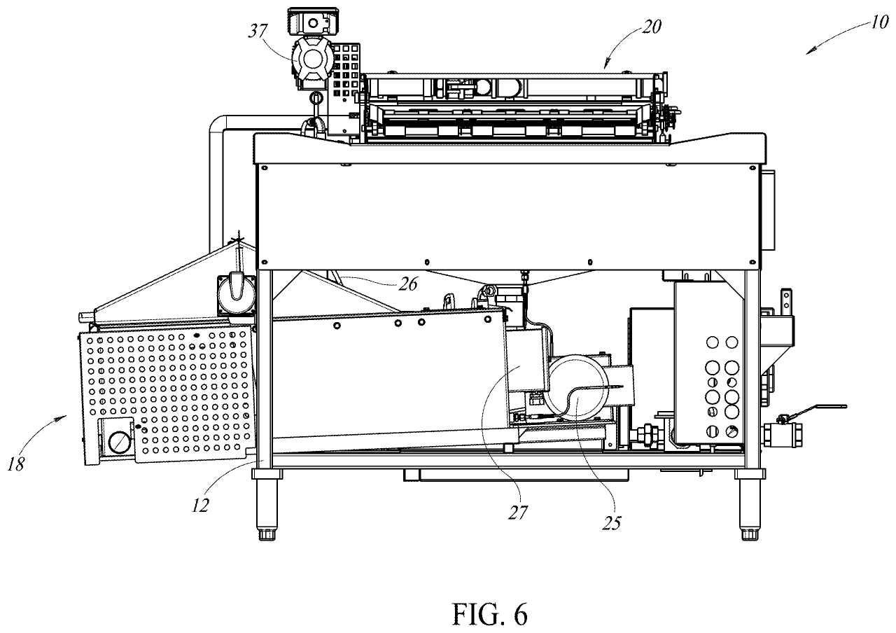

FIGS. 1-8 illustrate a donut frying machine 10, according to one example embodiment. The donut frying machine 10 includes a frame 12, a heating apparatus 14, a conveyor system 16, a fluid supply/drain apparatus 18 (hereinafter referred to as fluid supply apparatus 18), a submerger system 20, and a vessel or tank 22. With specific reference to FIG. 2 in which the submerger system 20 is removed for clarity of illustration and description, the donut frying machine 10 is generally configured to be fed uncooked dough products, such as donuts, other similar batter or dough food products, or any uncooked food item. The dough products may be fed via trays, hoppers, or other similar systems and structures, to the donut frying machine 10 at an entrance region 23. The vessel or tank 22 of the donut frying machine 10 includes shortening or other cooking medium, such as shortening substitutes, including coconut oil or vegetable oil, or water in some embodiments. The shortening may be supplied to the tank 22 via any known system or apparatus. In an embodiment, the donut frying machine 10 includes the fluid supply apparatus 18, which may be fluidly coupled to a supply of frying or cooking medium. The fluid supply apparatus 18 can include pump(s), motor(s) 25, valve(s), conduit(s) 26, electrical equipment 27, valves 28, etc., which can supply shortening or other frying medium to the tank 22. The fluid supply apparatus 18 can also include outlets, valves, and/or conduits to drain the shortening or other frying medium. When the tank 22 includes the shortening or other frying medium, the heating apparatus 14 may heat, regulate, or otherwise maintain a desired temperature of the shortening. The heating apparatus 14 may take the form of a gas-fired heating apparatus or an electrical heating apparatus. For example, in one embodiment of a gas-fired heating apparatus, the heating apparatus 14 includes one or more blowers 29, flues 30, conduits 31, valves, regulators 33, manifolds, switches, exhausts, motors, and/or burners. The heating apparatus 14 may include or be separately coupled to a gas supply. As the heating apparatus 14 is operated, the burners, for example, burner tubes 35 positioned in the tank 22 are heated, which in turn heat the shortening or other frying medium in the tank 22.

The conveyor system 16 is generally configured to move the uncooked donuts from the entrance region 23 through the tank 22 and after cooking or frying the uncooked donuts to an exit region 41. The conveyor system 16 can include one or more motors 37, trays, chains 38, separating shafts 39, etc. The one or more motors 37 can drive the chains 38 and the separating shafts 39 in a certain direction, for example, clockwise direction, which moves the donuts from the entrance region 23 to the exit region 41. As the conveyor system 16 is operated, the uncooked donuts move through the shortening and cook as the heating apparatus 14 heats the shortening.

As described earlier, cooking both sides of the donuts generally have been achieved by providing a flipping device. The submerger system 20 can facilitate cooking both sides of the donuts without utilizing a mechanism or device to flip the donuts. In particular, the submerger system 20 includes a cascade system 42, a roller apparatus 44, and one or more submerger plates (e.g., submerger plates 45, 47). The cascade system 42 includes a manifold 46 which is configured to supply shortening or other frying medium. The manifold 46 includes conduits, valves, fittings, etc. One of the conduits includes an inlet 48 which is coupled to a shortening supply. In some embodiments, the shortening supply may be a separate tank or vessel having the shortening, and in other embodiments, the shortening supply may be provided from the shortening in the tank 22. The cascade system 42 includes one or more exit conduits 50 through which the shortening is supplied into the tank 22 as described in more detail below.

The cascade system 42 includes a cascade lid 51 and a pair of mounting plates 52. The mounting plates 52 are mounted to the conveyor system 16 of the donut drying machine 10. Each of the mounting plates 52 is coupled to the cascade lid 51. In this manner, the cascade lid 51 is also mounted to the conveyor system 16 by extension of the mounting plates 52. The cascade lid 51 is positioned above the tank 22 and proximate to the entrance region 23. The cascade lid 51 includes one or more recesses 54. Each recess 54 is sized and shaped to receive the one or more exit conduits 50. In this manner, the shortening flows from the exit conduits 50 through the cascade lid 51. The cascade system 42 includes one or more diffusers 55 and troughs 56. Each of the diffusers 55 and troughs 56 is positioned adjacent to one or more recesses 54. The diffuser 55 includes a receiving portion 57, which is provided by a U-shaped structure. Ends of the U-shaped structure abut against the mounting plates 52. The one or more exit conduits 50 extend into the receiving portion 57. Thus, as the shortening is supplied via the manifold 46, the shortening is received in the receiving portion 57 and fills the receiving portion 57. The trough 56 is generally sized and shaped to be received adjacent to the recess 54 and surrounds the diffuser 55. The trough 56 includes a base flange 58 and a pair of side flanges 59 that extend angularly from respective sides of the base flange 58. The trough 56 includes a pair of end flanges 60 that are shaped like a valley and extend from respective ends of the side flanges 59.

As described above, the trough 56 surrounds the diffuser 55. In particular, the diffuser 55 is seated on the base flange 58 of the trough 56. Each of the vertical flanges of the diffuser 55 is spaced apart from respective side flanges 59 of the trough 56 to define a side receiving region 61. Thus, as the shortening fills up the receiving portion 57 of the diffuser 55, the shortening overflows the diffuser 55 and moves to the side receiving regions 61. The shortening thereafter fills up the side receiving regions 61 and as the shortening overflows, the valley shaped end flanges 60 direct the shortening into the tank 22. The shortening directed into the tank 22 flows onto the exposed side of the donut. Thus, the non-exposed side of the donut is fried or cooked by the shortening in the tank 22 and the overflowing shortening from the cascade system 42 flows and cooks the exposed side of the donut.

The cascade system 42 further includes the roller apparatus 44. The roller apparatus 44 is generally operable to submerge the donuts as they move through the vessel 22. By applying pressure to submerge the donuts, the roller apparatus 44 facilitates cooking or frying both sides of the donuts. The roller apparatus 44 includes a roller 63 having a roller shaft 64 which is coupled to a first submerger plate 47. The first submerger plate 47 encompasses a different bend configuration than the other submerger plates 45. The first submerger plate 47 has a bend up on a leading edge so that product (e.g., donuts) can move under the first submerger plate 47 without being caught or trapped. The remainder of the submerger plates 45 are configured in such a way to overlap each other which prevents product (e.g., donuts) from being caught. The roller apparatus 44 includes a drive system 65 which rotatably moves by contact with the chain(s) 38. The drive system 65 includes a drive shaft 66 having gears 67 that engage the chain(s) 38 of the conveyor system 16. The drive system 65 includes a driven shaft 68 that engages with the drive shaft 66 and the roller 63. Thus, as the chain(s) moves 38, the drive shaft 66 and the driven shaft 68 consequently submerge the donuts as they pass under the roller 63. Again, in this manner, the roller apparatus 44 of the cascade system 42 facilitates cooking or frying both sides of the donuts without using a flipping device.

The submerger system 20 includes one or more submerger plates (e.g., submerger plates 45, 47) that are positioned adjacent to each other. At least one of the one or more submerger plates (e.g., submerger plates 45, 47) is positioned adjacent to the roller apparatus 44. The one or more submerger plate (e.g., submerger plates 45, 47) includes a base plate 72 and a pair of handle plates 73 that extend outwardly from the base plate 72. Each of the one or more submerger plates (e.g., submerger plates 45, 47) is positioned within the frame 12 via the handle plates 73. The submerger plate (e.g., submerger plates 45, 47) is generally configured to submerge the donuts as they move through the vessel 22. Thus, as the donuts move along the vessel 22, when the donuts are positioned under the submerger plate (e.g., submerger plates 45, 47), the submerger plate (e.g., submerger plates 45, 47) facilitates the donuts being fully submerged in the shortening, and as a result both sides of the donuts are cooked or fried.

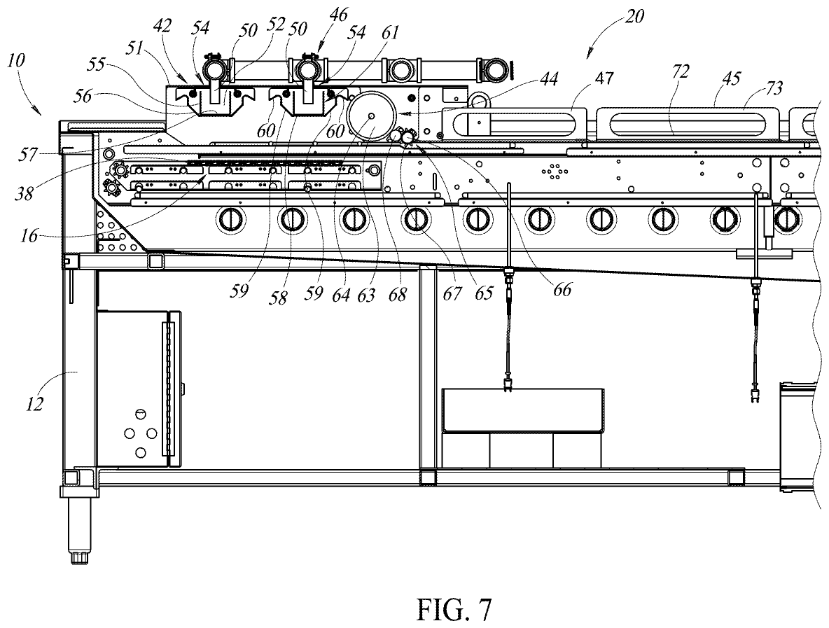

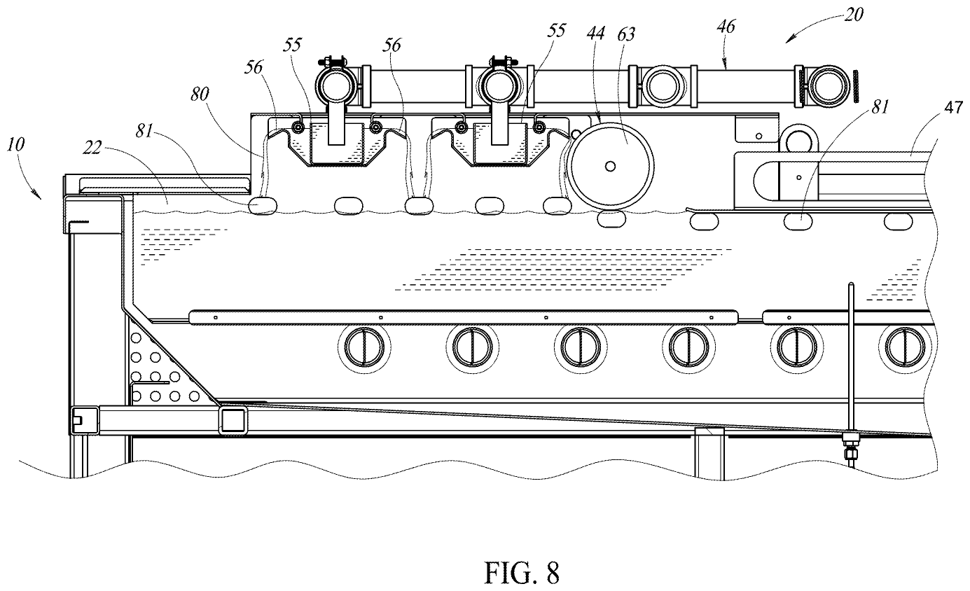

FIG. 8 illustrates the portion of the cross-sectional view of FIG. 7 with certain components removed for clarity of description and illustration. In FIG. 8, operation of the submerger system 20 is illustrated in more detail. As shown therein, overflowing shortening 80 flows from the diffusers 55 and troughs 56 to cook or fry donuts 81 positioned in the tank 22. The shortening 80 flowing from the cascade system 42 cooks an exposed surface or portion of the donut 81, while the shortening 80 in the tank 22 cooks or fries the un-exposed portion of the donut 81. Similarly, the roller apparatus 44 applies pressure and submerges the donut 81 as it moves under the roller 63. Likewise, the submerger plate (e.g., submerger plates 45, 47) facilitates submerging the donut 81 such that the shortening in the tank 22 cooks or fries the donut 81.

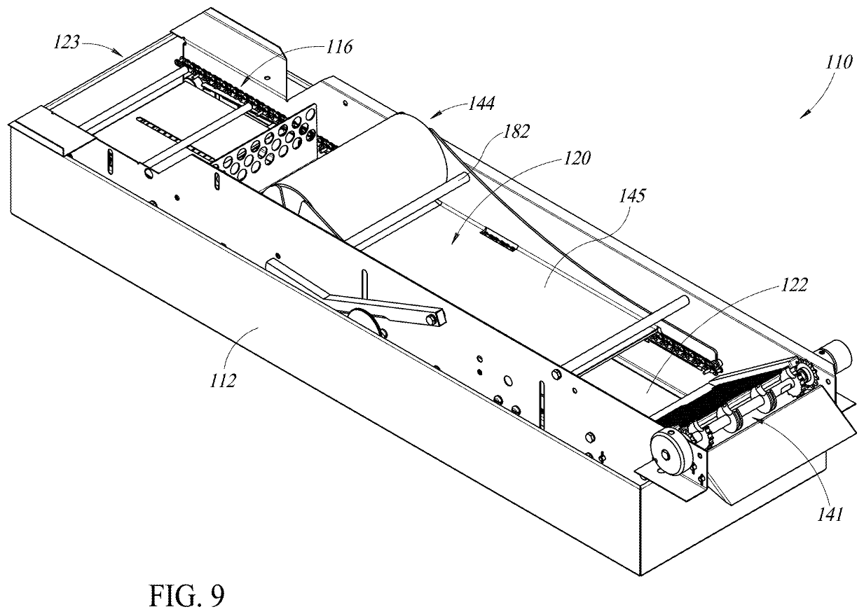

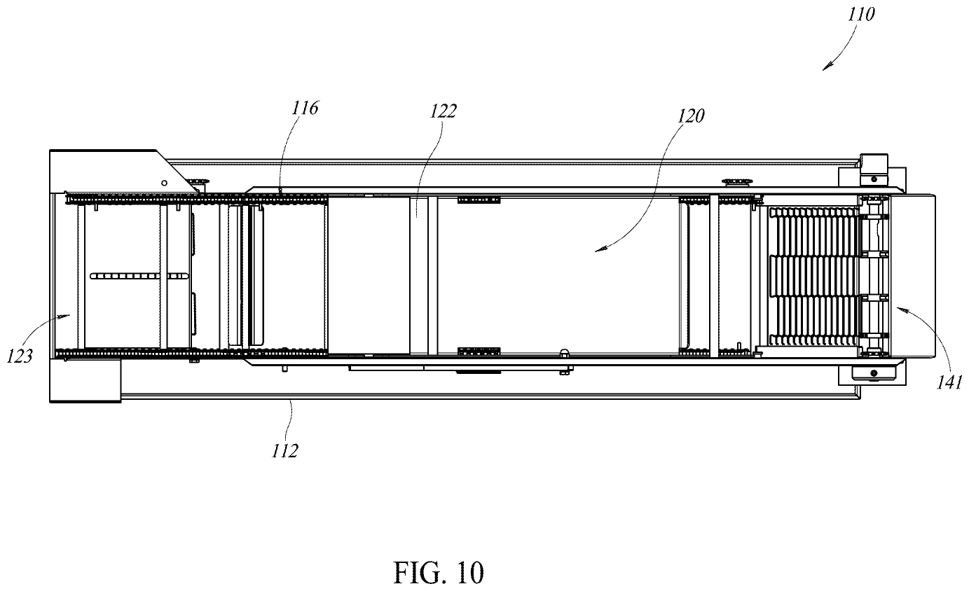

FIGS. 9 and 10 illustrate a donut frying machine 110, according to another example embodiment. The donut frying machine 110 includes a frame 112, a submerger system 120, a vessel or tank 122, and a conveyor system 116. The donut frying machine 110 may also include a heating apparatus and a fluid supply/drain apparatus similar to the ones described above. As shown in FIG. 9, the donut frying machine 110 is generally smaller than the donut frying machine 10 and is a simplified embodiment of the donut frying machine 10. The conveyor system 116, as described above, is generally configured to move the uncooked donuts from an entrance region 123 through the tank 122 and after cooking or frying the uncooked donuts to an exit region 141. The conveyor system 116 can include, again, one or more motors, trays, chains, separating shafts, etc. The one or more motors can drive the chains and the separating shafts in a certain direction, for example, clockwise direction, which moves the donuts from the entrance region 123 to the exit region 141. As the conveyor system 116 is operated, the uncooked donuts move through the shortening and cook as the heating apparatus heats the shortening.

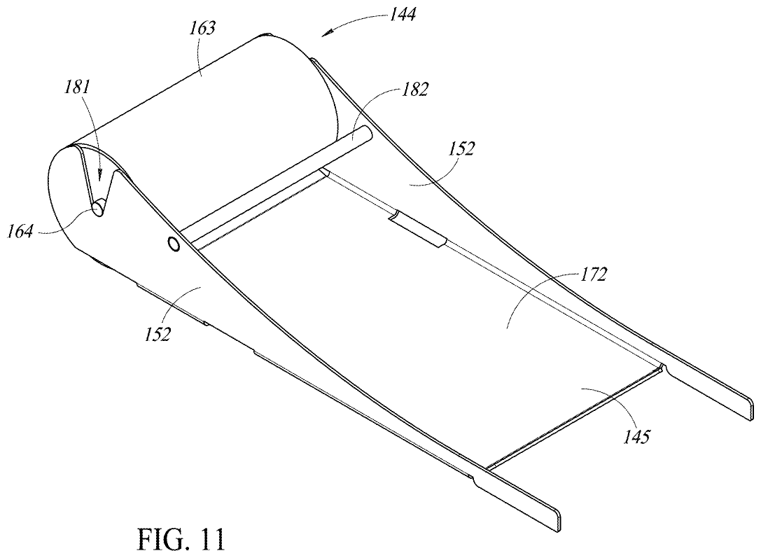

The submerger system 120 includes a roller apparatus 144 and a submerger plate 145. FIG. 11 illustrates the submerger system 120 in more detail. With reference to FIGS. 9-11, the roller apparatus 144 includes a roller 163 having a roller shaft 164. The submerger plate 145 includes a pair of mounting plates 152, and each of the mounting plates 152 includes a receiving recess 181 which rotatably receives the roller shaft 164. In this manner, the roller 163 rotates about the receiving recess 181. The roller 163 is engagably coupled to the conveyor system 116. Thus, as the conveyor system 116 moves, the roller 163 moves therewith. Again, the roller apparatus 144 of the submerger system 120 facilitates cooking or frying both sides of the donuts without using a flipping device by applying pressure on the donuts to submerge the donuts in the shortening of the tank or vessel 122. The submerger plate 145 is coupled to the mounting plates 152 and includes a base plate 172 that extends between the mounting plates 152, and a shaft 182 that connects the mounting plates 152. The submerger plate 145 encompassing the mounting plates 152, the base plate 172, and the shaft 182 is interposed between the frame 112 and generally configured to submerge the donuts as they move through the vessel 122. Thus, as the donuts move along the vessel 122, when the donuts are positioned under the submerger plate 145, the submerger plate 145 facilitates the donuts being fully submerged in the shortening, and as a result both sides of the donuts are cooked or fried. In some embodiments, the submerger system 120 may optionally also include a cascade system, similar to the cascade system 142 of FIGS. 1-8.

The various embodiments described above can be combined to provide further embodiments. For example, in some embodiments, any number of cascade systems, roller apparatuses, and submerger lids may be provided, including omitting one or more of the cascade systems, roller apparatuses, and submerger lids. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A machine for cooking a food item having at least a first portion and a second portion, comprising:
a vessel sized and shaped to receive a frying medium, the vessel having an entrance region and an exit region;
a frame that coupleably receives the vessel; and
a submerger system that cooks at least the first and the second portions of the food item.

2. The machine of claim 1 wherein the submerger system includes a cascade system which provides the frying medium to cook the first portion while the frying medium in the vessel cooks the second portion which is opposite the first portion.

3. The machine of claim 2 wherein the cascade system includes a trough having a pair of arcuate end flanges which direct the frying medium to the food item to cook the first portion.

4. The machine of claim 2 wherein the cascade system includes a manifold which is fluidly coupled to a supply of frying medium, the manifold configured to direct the frying medium to the food item to cook the first portion.

5. The machine of claim 2 wherein the cascade system includes:
a manifold fluidly coupled to a supply of frying medium, the manifold including one or more fluid outlets;
a diffuser having a receiving portion which receives the one or more fluid outlets; and
a trough arranged to surround the diffuser.

6. The machine of claim 5 wherein the trough includes a base flange that receives the diffuser, a side flange that extends from the base flange, and an end flange that has an arcuate shape which is configured to direct the frying medium to the food item to cook the first portion.

7. The machine of claim 1, comprising:
a conveyor apparatus that facilitates movement of the food item from the entrance region to the exit region; and
a roller apparatus which is coupled to the conveyor apparatus, movement of the conveyor apparatus causing rotatable movement of the roller apparatus.

8. The machine of claim 7 wherein the roller apparatus includes a roller which, when moved, submerges the food item in the frying medium in the vessel.

9. The machine of claim 7 wherein the roller apparatus includes a drive system that is coupled to the conveyor apparatus, the drive system rotatably moves a roller when the conveyor apparatus moves.

10. The machine of claim 1 wherein the submerger system includes one or more submerger plates, the one or more submerger plates positioned proximate to the vessel and arranged to submerge the food item in the frying medium in the vessel.

11. A submerger system that is configured to cook a food item, the submerger system comprising:
a cascade system which provides a first volume of shortening to cook an exposed portion of the food item;
a roller apparatus having a roller which, when positioned above the food item, submerges the food in a second volume of shortening; and
one or more submerger plates, the one or more submerges arranged to submerge the food item in the second volume of shortening.

12. The submerger system of claim 11 wherein the cascade system includes a manifold which is fluidly coupled to a supply of shortening, the supply of shortening providing the first volume of shortening.

13. The submerger system of claim 11 wherein the cascade system includes:
a cascade lid having a recess;
a manifold having an inlet positioned in the recess, the inlet configured to provide the first volume of shortening;
a diffuser positioned proximate to the recess, the diffuser having a U-shaped structure sized and shaped to receive the first volume of shortening provided by the inlet; and
a trough arranged to surround the diffuser, the trough configured to receive the first volume of shortening from the diffuser.

14. The submerger system of claim 13 wherein the trough includes a base flange which receives the diffuser, a pair of side flanges which extend outwardly from the base flange, and a pair of end flanges, each one of the end flange extending outwardly from a respective side flange.

15. The submerger system of claim 14 wherein each end flange has a valley-shaped structure which is sized and shaped to direct the first volume of shortening from the trough to the exposed portion of the food item.

16. The submerger system of claim 11 wherein the roller apparatus includes a drive system and a roller, the drive system configured to rotate the roller.

17. The submerger system of claim 11 comprising a plurality of submerger plates arranged adjacent to each other, and wherein a first one of the plurality of submerger lids positioned adjacent to the roller apparatus.

18. A method for cooking food item in a frying machine, the method comprising:
supplying uncooked food items via an entrance region of the frying machine;
submerging the uncooked food item in a first food frying medium to cook a portion of the food item immersed in the first food frying medium; and
supplying a second food frying medium to an exposed portion of the food item that faces away from the first food frying medium.

19. The method of claim 18, comprising immersing the food item in the first food frying medium via a roller apparatus.

20. The method of claim 18, comprising immersing the food item in the first frying medium via a submerger plate.
